(19) United States
(12) Patent Application Publication
(10) Pub. No.: US 2026/0268435 A1
(43) Pub. Date: Sep. 10, 2026

(54) CACHE FOR TEXTURE ELEMENTS

(71) Applicant: Samsung Electronics Co., Ltd., Suwon-si (KR)

(72) Inventors: Zhenhong LIU, Santa Clara, CA (US); Wilson Wai Lun FUNG, Milpitas, CA (US); Balakrishnan SUNDARARAMAN, Austin, TX (US); Akshay MOTE, Folsom, CA (US); Soubhagya SUTAR, Leander, TX (US)

(21) Appl. No.: 19/292,894

(22) Filed: Aug. 6, 2025

Related U.S. Application Data
(60) Provisional application No. 63/767,390, filed on Mar. 5, 2025.

(51) Int. Cl. G06T 1/60; G06T 15/00

(52) U.S. Cl. CPC G06T 1/60; G06T 15/005

(57) ABSTRACT

A cache for texture elements. In some embodiments, a method includes: storing, by a first thread executing in a processing circuit, a first uncompressed texel in a first partition, of a first cache; and storing, by a second thread executing in the processing circuit, a second uncompressed texel in a second partition of the first cache, the second partition being different from the first partition.

### CROSS-REFERENCE TO RELATED APPLICATION

This application claims the priority benefit under 35 U.S.C. § 119(e) of U.S. Provisional Application No. 63/767,390, filed on March 5, 2025, the disclosure of which is incorporated by reference in its entirety as if fully set forth herein.

### TECHNICAL FIELD

The disclosure generally relates to graphics. More particularly, the subject matter disclosed herein relates to improvements to a cache for texture elements.

### SUMMARY

Graphics processing units (GPUs) may generate two-dimensional images from three-dimensional models using information such as textures in the models. The textures may be represented by texture elements referred to as texels. Frequent re-use of texels may result in performance degradation if the texels are retrieved from a memory external to the GPU each time they are used.

To solve this problem, a texture cache, for storing compressed texels, may be implemented in the GPU.

One issue with the above approach is that such an approach may avoid frequent fetching of the same texel from memory, but it may still involve frequent decompressing of a frequently used texel.

To overcome these issues, systems and methods are described herein for implemented a post-decompression cache in a GPU. The post-decompression cache may be partitioned and asymmetrical, to improve its performance. The texture cache may store texel data in an uncompressed form or as compressed texel blocks. Compressed texel blocks may be decompressed to generate texel data. While the texture cache may reduce the number of fetches to memory, it may not reduce the number of decompressions; texel decompression, which may be a power and compute-intensive process, may be performed again even if the same texel is being requested on a later occasion. The post-decompression cache helps to avoid these frequent decompressions by storing the decompressed texel data.

The above approaches improve on previous methods because it reduces the need for repeated decompression of frequently used texels, and its partitioned, asymmetric nature maximizes reuse and enables faster lookup while maintaining a low hardware footprint.

According to an embodiment of the present disclosure, there is provided a method, including: storing, by a first thread executing in a processing circuit, a first uncompressed texel in a first partition, of a first cache; and storing, by a second thread executing in the processing circuit, a second uncompressed texel in a second partition of the first cache, the second partition being different from the first partition.

In some embodiments, the method further includes storing, by a third thread executing in the processing circuit, a third uncompressed texel in the first partition, of the first cache, wherein the first thread is part of a first thread group, the third thread is part of the first thread group, and the second thread is part of a second thread group different from the first thread group.

In some embodiments, the first thread group renders a first group of pixels, and the second thread group renders a second group of pixels, different from the first group of pixels.

In some embodiments, the first group of pixels includes four adjacent pixels.

In some embodiments, the first partition is configured to be written only by threads of the first thread group.

In some embodiments, the second partition is configured to be written only by threads of the second thread group.

In some embodiments, the first partition includes: a first way group including one or more ways, and a second way group including one or more ways.

In some embodiments, the first way group is configured to be written only by the first thread, and the second way group is configured to be written only by the third thread.

In some embodiments, the first way group is configured to be read by the first thread and by the second thread.

In some embodiments, the method further includes searching for a fourth texel, by the first thread, in the first partition, the fourth texel being identified by a texel identifier; the searching including searching a set of texel tags of the first cache for a first texel tag, associated with the fourth texel, and the fourth texel being stored in a second cache in compressed form.

In some embodiments, the method further includes: looking up the fourth texel in the second cache based on the texel identifier; and receiving the first texel tag from the second cache.

According to an embodiment of the present disclosure, there is provided a system including: one or more processors; and a memory storing instructions which, when executed by the one or more processors, cause performance of: storing, by a first thread executing in a processing circuit, a first uncompressed texel in a first partition, of a first cache; and storing, by a second thread executing in the processing circuit, a second uncompressed texel in a second partition of the first cache, the second partition being different from the first partition.

In some embodiments, the instructions, when executed by the one or more processors, further cause performance of storing, by a third thread executing in the processing circuit, a third uncompressed texel in the first partition, of the first cache, wherein the first thread is part of a first thread group, the third thread is part of the first thread group, and the second thread is part of a second thread group different from the first thread group.

In some embodiments, the first thread group renders a first group of pixels, and the second thread group renders a second group of pixels, different from the first group of pixels.

In some embodiments, the first group of pixels includes four adjacent pixels.

In some embodiments, the first partition is configured to be written only by threads of the first thread group.

In some embodiments, the second partition is configured to be written only by threads of the second thread group.

In some embodiments, the first partition includes: a first way group including one or more ways, and a second way group including one or more ways.

In some embodiments, the first way group is configured to be written only by the first thread, and the second way group is configured to be written only by the third thread.

According to an embodiment of the present disclosure, there is provided a system including: means for processing; and a memory storing instructions which, when executed by the means for processing, cause: storing, by a first thread executing in a processing circuit, a first uncompressed texel in a first partition, of a first cache; and storing, by a second thread executing in the processing circuit, a second uncompressed texel in a second partition of the first cache, the second partition being different from the first partition.

### BRIEF DESCRIPTION OF THE DRAWINGS

In the following section, the aspects of the subject matter disclosed herein will be described with reference to exemplary embodiments illustrated in the figures, in which:

FIG. 1A is a system level block diagram, according to an embodiment.

FIG. 1B is a block diagram of a portion of a computing system, according to an embodiment.

FIG. 1C is a block diagram of a graphics processing system and an associated memory, according to an embodiment.

FIG. 1D is a block diagram of a graphics processing system and an associated memory, according to an embodiment.

FIG. 2A is a schematic drawing of a partition of an asymmetric cache, according to an embodiment.

FIG. 2B is a hybrid block and flow diagram of texel data management, according to an embodiment.

FIG. 3A is a flow chart of a method, according to an embodiment.

FIG. 3B is a flow chart of a method, according to an embodiment.

FIG. 3C is a flow chart of a method, according to an embodiment.

FIG. 4 is a flow chart of a method, according to an embodiment.

FIG. 5 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

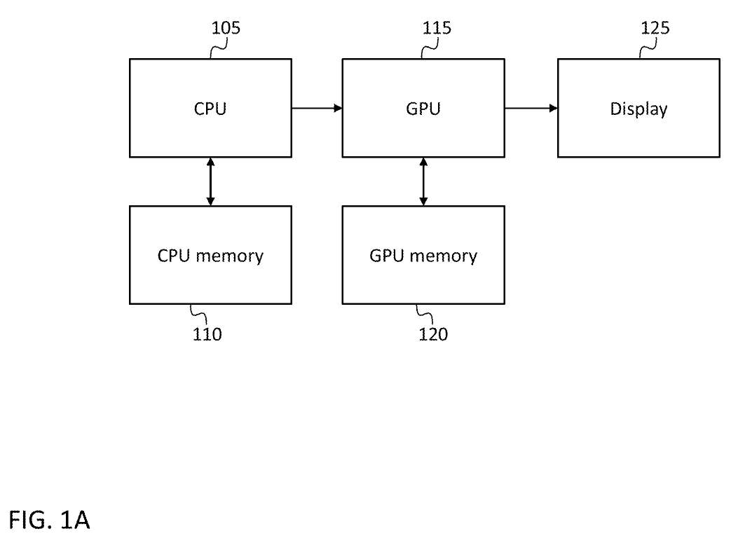

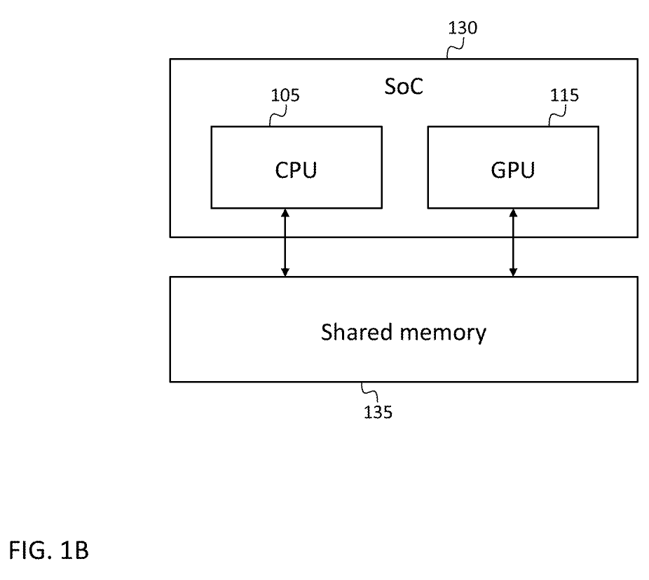

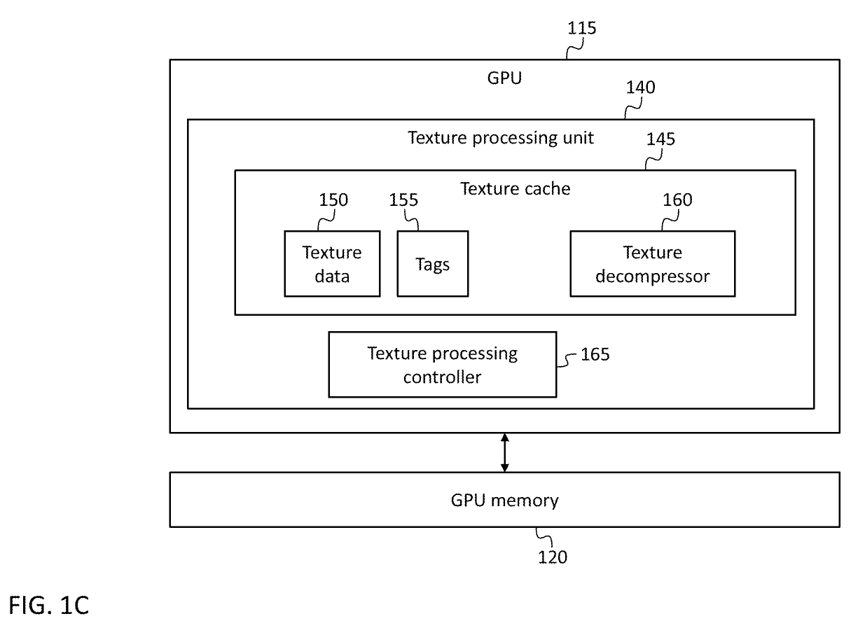

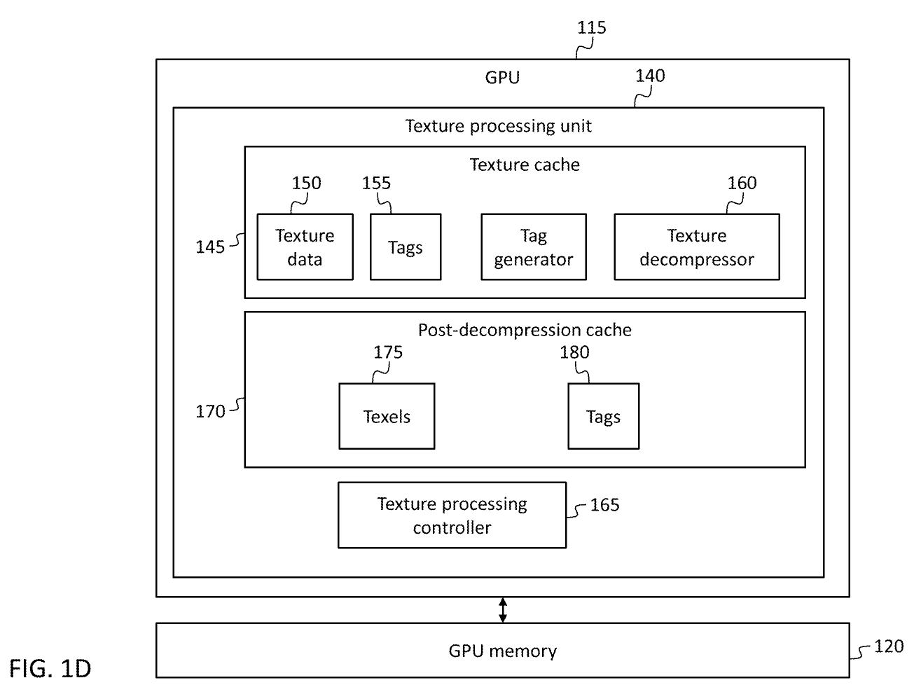

FIG. 1A depicts a block diagram of a computing system. A central processing unit (CPU) 105 performs various data processing operations, using a CPU memory 110, and generates commands, e.g., draw commands, that are sent to a graphics processing unit (GPU) 115. The GPU 115 processes the commands using a GPU memory 120, and generates, based on the commands, images which are sent to a display 125 to be displayed. Each image may include (e.g., consist of) a plurality (e.g., a two-dimensional array) of pixels, each of which, when received by the display 125, may be displayed by a respective corresponding pixel of the display.

In some embodiments (such as the embodiment illustrated in FIG. 1B), the CPU 105 and the GPU 115 may be on one chip (e.g., on one silicon chip) which may be referred to as a system on chip (SoC). In some embodiments (e.g., in an embodiment in which the CPU 105 and the GPU 115 are on one chip, as shown in FIG. 1B), the CPU 105 and the GPU 115 may share a memory (which may be referred to as a shared memory 135). In such an embodiment, the shared memory 135 may operate as both the CPU memory 110 and the GPU memory 120.

The commands sent by the CPU 105 to the GPU 115 may include various pieces of information allowing the GPU 115 to generate an image. For example, a command from the CPU may instruct the GPU 115 how to generate a portion of a two-dimensional image from information about a three-dimensional scene constructed (as an internal numerical model) by the CPU (for example, as part of the operation of a video game). The information may include the location of the viewer (e.g., a virtual camera obtaining an image of the scene), the locations of one or more light sources illuminating the scene, and information about objects in the scene (e.g., objects from which light from the light sources may reflect into the camera). Such conversion from a model of a three-dimensional scene to a two-dimensional image may be referred to as rendering.

A command sent by the CPU 105 to the GPU 115 may include, for example, information about a portion of the surface of an object to be displayed, including the location of the portion of the surface, the orientation of the portion of the surface (as defined, for example, by the components of a vector that is normal (e.g., perpendicular) to the surface), and a set of characteristics of the surface, together referred to as the texture of the surface, which describe how light interacts with (e.g., reflects from) the surface. Such characteristics may include, for example, the color of the surface and the roughness of the surface. The surface of an object to be rendered may be divided up into small units within each of which the texture may be uniform. The texture characteristics of each such unit may be contained in a texture element data structure referred to as a texel.

When performing rendering of an object, the GPU 115 may fetch texels, for a plurality of points on the surface of the object, from the GPU memory 120 (e.g., from the shared memory 135), and use the texels to determine how light reflects from the points on the surface of the object. To conserve memory, the texels may be stored in compressed form in the GPU memory 120 (e.g., in the shared memory 135), in a plurality of blocks, referred to as compressed texel blocks, each of which may include a plurality of texels (e.g., a four by four array of texels, or a twelve by twelve array of texels) compressed together to form the compressed texel block. The GPU 115 may extract (e.g., decompress) each texel from the compressed texel block that contains the texel (to form a decompressed texel, or an “uncompressed” texel), before using the texel. As used herein, an “uncompressed” texel is one that is not compressed, and a “decompressed” texel is an uncompressed texel that has been obtained by decompressing, e.g., by decompressing a compressed texel block. In a command received from the CPU 105, each texel may be identified by a texel identifier, which may be a relatively long identifier, e.g., it may include (i) an address in the GPU memory 120 of the compressed texel block containing the texel, as well as (ii) the x and y coordinates of the texel within the array of texels that is included in the compressed texel block.

As mentioned above, frequent re-use of texels may result in performance degradation if the texels are retrieved from a memory external to the GPU each time they are used. To solve this problem, a texture cache may be implemented in the GPU that stores the texel data locally, thereby eliminating the need to fetch a texel from memory if it is already stored in the texture cache. The texture cache may store some texels (referred to herein as non- compressed texels), in uncompressed form, and other texels in compressed form within compressed texel blocks. Texture processing may be performed by a texture processing unit 140 (which may be a texture processing circuit) of the GPU 115. The texture processing unit 140 may include, as shown in FIG. 1C, a texture cache 145, which may store compressed texels (and non-compressed texels, as discussed in further detail below) in a texture data storage region 150 and which may store the corresponding tags in a tag region 155. The texture data storage region 150 and the corresponding tag region 155 need not each be a contiguous set of storage locations, and the cached texture data (the compressed texels) may be interleaved, in a single physical storage region, with the corresponding tags. The texture cache 145 may be a cache with, for example, each cache line corresponding to a respective portion of a region, of the GPU memory 120, used to store compressed texels, and a tag value (or “texel block tag”) associated with each cache line specifying which address, within the portion, is currently cached in the cache line. The texture cache 145 may further include a texture decompressor 160. In some embodiments, the texture decompressor 160 is a separate circuit that is not included in the texture cache 145. The texture processing unit 140 may be controlled by a texture processing controller 165, which may be or include a processing circuit.

In some embodiments, when a command received from the CPU 105 by the GPU 115 calls for the use of a particular texel, the texture processing unit 140 may request the texel from the texture cache 145, which, in case of a cache miss, may retrieve the compressed texel block containing the requested texel from the GPU memory 120, based on the texel identifier. In either case (whether the request resulted in a cache hit or in a cache miss) the texture cache 145 may then decompress the texel, using the texture decompressor 160, send the decompressed texel to the texture processing unit 140 and cache the compressed texel block (e.g., store the compressed texel block in the texture cache 145). If the texture processing unit 140 subsequently requests the same texel from the texture cache 145 while the compressed texel block containing the requested texel remains in the texture cache 145, the texture cache 145 may again decompress the texel, using the texture decompressor 160, and send the decompressed texel to the texture processing unit 140. As such, the texture cache 145 may, in the event of a cache hit, eliminate the need to again retrieve the compressed texel block from the GPU memory 120 (e.g., from the shared memory 135).

In such an embodiment, however, repeatedly decompressing the texel may not be avoided. As such, in some embodiments, the GPU 115 further includes a post-decompression cache 170 which stores decompressed texels, as shown in FIG. 1D. The post-decompression cache 170 may include a region 175 for data (decompressed texels) and a region 180 for tags. As in the case of the texture cache 145, the texture data storage region 175 and the corresponding tag region 180 need not each be a contiguous set of storage locations, and the cached texture data (the uncompressed texels) may be interleaved, in a single physical storage region, with the corresponding tags. The tags stored in the region 180 for tags of the post-decompression cache 170 may be referred to as texel tags, each of which may include the cache line number of the cache line within which the compressed texel block is stored in the texture cache 145, a block identifier which may identify the block within the cache line, and the x and y coordinates of the texel within the array of texels that is included in the compressed texel block. The use of the post-decompression cache 170 may reduce the need to extract a decompressed texel from the compressed texel block that contains it, when such an extraction has already been performed. For example, an additional extraction may be avoided if a requested texel is already stored in the post-decompression cache 170.

The post-decompression cache 170 may be a partitioned, asymmetric cache (discussed in further detail below). The reasons for this relate to the manner in which texels are used. A GPU 115 may include a plurality of cores, each of which may be single instruction, multiple data (SIMD) processing circuit. In GPU rendering, such a single instruction, multiple data processing circuit may be used to execute the same instruction on multiple data elements concurrently, significantly improving performance. A single instruction, multiple data processing circuit may be equivalent, from a data processing perspective, to an array of processors each executing the same set of instructions, simultaneously, to perform a process on a respective stream of input data to generate a corresponding respective stream of output data. These processes, each processing a respective stream of data in a single instruction, multiple data processing circuit, may be referred to as threads, or “lanes”. As such, single instruction, multiple data threads or lanes may be the individual processing units within a GPU's architecture that operate on separate data items based on the same instruction.

The threads may work together in groups of threads (or “thread groups”) when performing rendering. In such an embodiment each thread of a thread group may process (e.g., render) a group of pixels (e.g., adjacent pixels), with each thread rendering a respective pixel of the group of pixels. For example, if each thread group renders four adjacent pixels, then each thread group may include four threads, each of which may process (e.g., render) a respective one of the four pixels in the group of pixels.

In such an embodiment the post-decompression cache 170 may be partitioned into a number of partitions equal to the number of thread groups. For example, if eight thread groups operate simultaneously (e.g., eight thread groups with four threads each, for a total of 32 threads), then the post-decompression cache 170 may be partitioned into eight partitions, which may operate independently, and each of which may cache texels (e.g., decompressed texels) for (and only for) a respective thread group of the eight thread groups. If each thread group generally processes a group pixels that is unrelated to (e.g., separated, in the image, from) each of the groups of pixels processed by the other thread groups, then such partitioning may improve the efficiency of the post-decompression cache 170, because, for example, each thread group may avoid searching portions of the post-decompression cache 170 that are unlikely to store the texels it needs. The post-decompression cache 170 may be strictly partitioned, e.g., it may prevent each thread group from accessing the partition associated with any other thread group, or it may be loosely partitioned, e.g., a first thread group may have only read access to the partition of another thread group, or the first thread group may have only secondary access to the partitions of other thread groups (e.g., the first thread group may search the partitions of other thread groups for a texel that it needs only if it is unable to find the texel it its own partition).

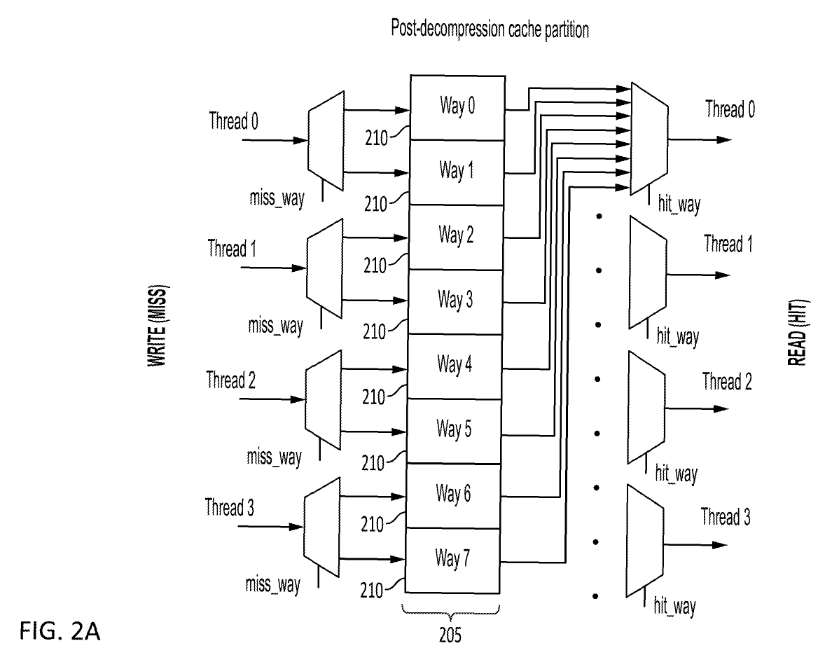

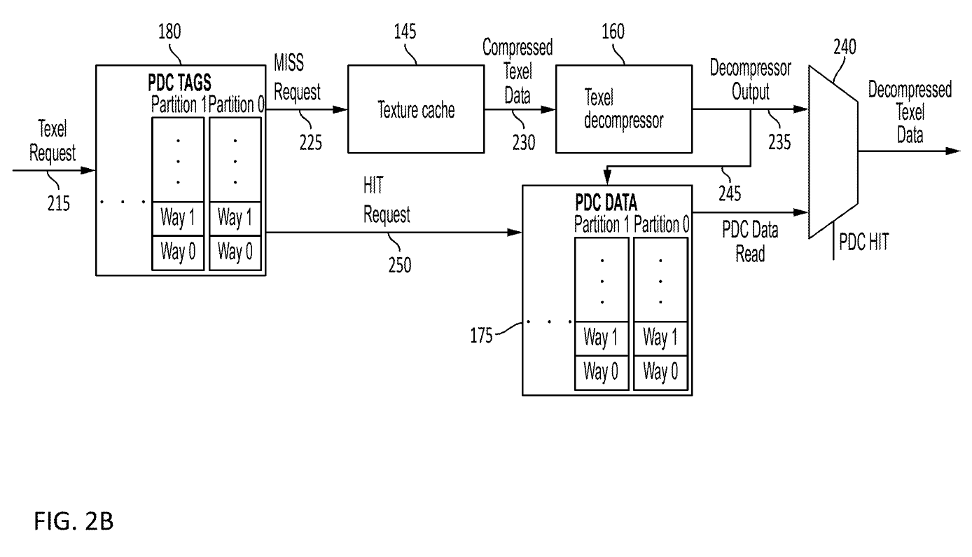

Each of the partitions may further be asymmetric (as mentioned above). Each partition may be divided into a plurality of portions, each portion including one or more ways, each portion corresponding to a respective thread of the thread groups. In such an embodiment the ways in a portion may be referred to as a “way group”. FIG. 2A shows a partition 205 of a post-decompression cache 170, in some embodiments. In the embodiment of FIG. 2A, each thread group includes four threads, and the partition accordingly is divided into four portions. In the example of FIG. 2A, the first portion (associated with thread 0) includes two ways 210, way 0 and way 1. Similarly, the second portion includes way 2 and way 3, the third portion includes way 4 and way 5, and the fourth portion includes way 6 and way 7. Each way may include both data (decompressed texels) and tags. In some embodiments, each way stores only one texel, and the corresponding tag. Each partition of the post-decompression cache 170 is asymmetric in the sense that each thread writes only to the portion of the partition that is allocated to the thread, but each thread searches all portions of the partition for any texel it may need. In some embodiments, when a thread searches the partition for a texel, the thread may first search the portion corresponding to the thread, and, if the texel is not found in this portion, the thread may search the other portions of the partition. When writing to the cache, the thread may write to the least recently used way 210 of its way group. The inclusion of multiple ways in a way group may have the advantage of providing multiple locations, for each thread, for the storing of texels. The restricting of each thread to a respective way group may have the advantage of reducing the complexity (and the hardware footprint) of the circuit through which the thread may save a texel in the post-decompression cache 170. In some embodiments, each portion of each partition has two ways (as in the example of FIG. 2A); in some embodiments, each portion of each partition has more than two ways, or fewer than two ways (e.g., one way).

Because every texel that is stored in the post-decompression cache 170 may have been fetched from the texture cache 145 immediately prior to being stored in the post-decompression cache 170, each texel tag identifying a decompressed texel in the post-decompression cache 170 may (as mentioned above) be generated based on the storage, in the texture cache 145, of the compressed texel block that contains the texel. This may result in relatively short texel tags. For example, the texture cache 145 may have a size of 256 cache lines, each cache line having a size of 128 bytes. Each texel tag may have a size of 21 bits, including (i) 8 bits to identify the cache line of the texture cache 145 within which the compressed texel block that contains the texel is stored, 4 bits to identify the location of the compressed texel block within the cache line, 8 bits for the x and y coordinates of the texel within the array of texels that is included in the compressed texel block (e.g., 4 bits for the x coordinate, and 4 bits for the y coordinate), and 1 valid bit.

When such a system of texel tags is used, the post-decompression cache 170 may obtain the texel tag from the texture cache 145 (e.g., from a tag generator 185 of the texture cache 145 (FIG. 1D)) prior to saving a decompressed texel and its tag in the post-decompression cache 170, or prior to searching for a texel tag in the post-decompression cache 170. To obtain the texel tag, the thread may look up the texel in the texture cache 145 by sending a lookup request to the texture cache 145. The lookup request may have the effect of (i) in the event of a cache hit, returning the texel tag for the requested texel and (ii) in the event of a cache miss, fetching the compressed texel block from the backing store (e.g., from the GPU memory 120 (e.g., from the shared memory 135)), saving the compressed texel block in the texture cache 145 and returning the texel tag to the thread.

FIG. 2B shows a process of using a post-decompression cache 170 (PDC), in some embodiments. A texel request, including a texel tag corresponding to the requested texel, may be received at 215, and, in response, the texel tags of a partition of the post-decompression cache 170 may be searched (the partition being the partition associated with the thread group of which the thread originating the request is a member). If the texel tag is not found, then a cache miss has occurred in the partition of the post-decompression cache 170, and the request is sent, at 225, to the texture cache 145. The texture cache 145 obtains, at 230, the compressed texel block (either from the texture cache 145 or, if another cache miss occurs in the texture cache 145, from the GPU memory 120 (e.g., the shared memory 135)), and extracts the decompressed texel that was requested, using the texture decompressor 160. The decompressed texel (which is the output of the decompressor, at 235) is returned to the requesting thread (via an output selector 240) and also saved, at 245, in the post-decompression cache 170. In the event of a cache hit (e.g., if the texel tag is found, when the partition of the post-decompression cache 170 is searched), then a request may be sent, at 250, to the data region of the post-decompression cache 170, the request including the texel tag and being directed to the way in which the texel tag was found.

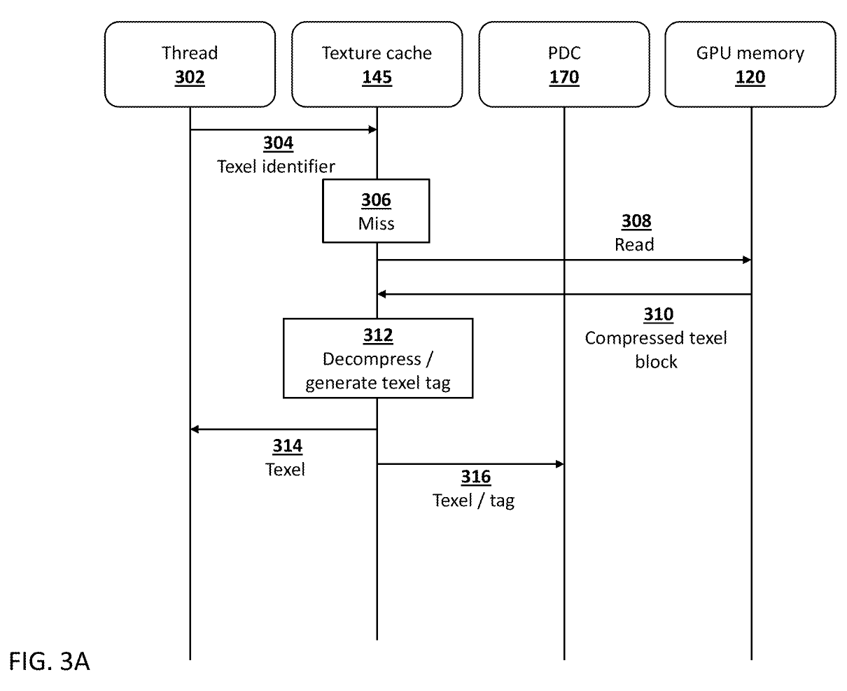

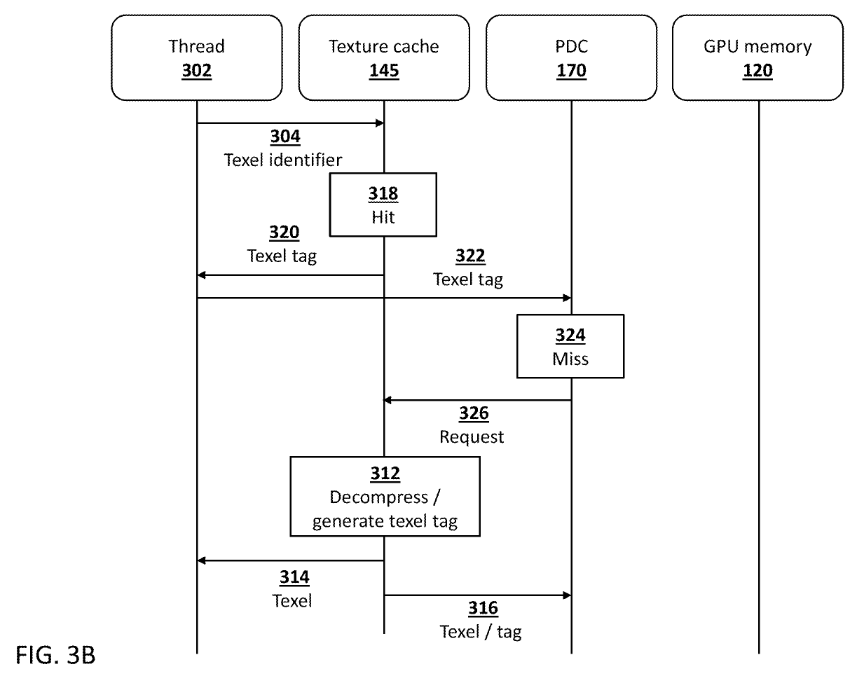

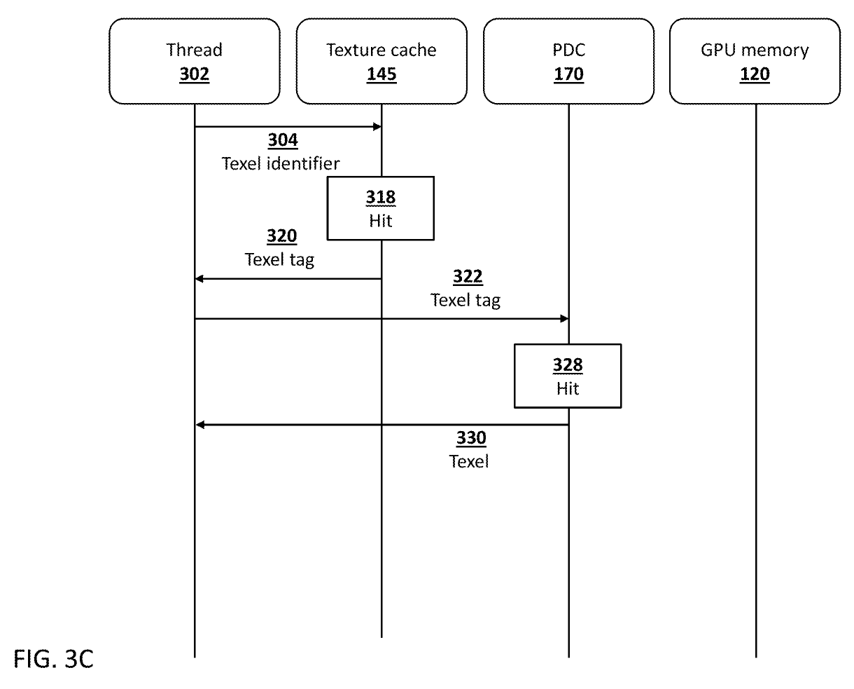

FIG. 3A shows the process of obtaining an uncompressed texel, in some embodiments, in a situation in which the texel is neither in the texture cache 145 nor in the post-decompression cache 170. A thread 302 looks up the texel, at 304, in the texture cache 145, by sending a lookup request including the texel identifier to the texture cache 145. At 306, a cache miss occurs in the texture cache 145, and it sends a read request, at 308, to the GPU memory 120, which returns, at 310, the compressed texel block containing the requested texel. At 312, the texture cache 145 decompresses the requested texel (e.g., it extracts the requested texel from the compressed texel block). The texture cache 145 then sends, (i) at 314, the requested texel to the thread 302, and, (ii) at 316, the requested texel and the texel tag to the post-decompression cache 170 for storage in the post-decompression cache 170.

FIG. 3B shows a similar process, in a situation in which the texel is in the texture cache 145, and not in the post-decompression cache 170. As in FIG. 3A, a thread 302 looks up the texel, at 304, in the texture cache 145, by sending a lookup request including the texel identifier to the texture cache 145. At 318, a cache hit occurs, and the texture cache 145 returns the texel tag, at 320 for the requested texel, to the thread 302. The thread 302 then sends, at 322, a request for the decompressed texel to the post-decompression cache 170, the request containing the texel tag. Based on the texel tag, the post-decompression cache 170 determines, at 324, that the requested texel is not present in the post-decompression cache 170 (a cache miss has occurred), and it sends, at 326, a request for the decompressed texel to the texture cache 145. The remainder of the process is the same as in FIG. 3A. At 312, the texture cache 145 decompresses the requested texel (e.g., it extracts the requested texel from the compressed texel block). The texture cache 145 then sends, (i) at 314, the requested texel to the thread 302, and, (ii) at 316, the requested texel and the texel tag to the post-decompression cache 170 for storage in the post-decompression cache 170.

FIG. 3C shows a similar process, in a situation in which the texel is stored both in the texture cache 145, and in the post-decompression cache 170. As in FIG. 3A, a thread 302 looks up the texel, at 304, in the texture cache 145, by sending a lookup request including the texel identifier to the texture cache 145. As in FIG. 3B, at 318, a cache hit occurs, and the texture cache 145 returns the texel tag, at 320, for the requested texel, to the thread 302. The thread 302 then sends, at 322, a request for the decompressed texel to the post-decompression cache 170, the request containing the texel tag. Based on the texel tag, the post-decompression cache 170 determines, at 328, that the requested texel is present in the post-decompression cache 170 (a cache hit has occurred), and it sends, at 330, the requested texel to the thread 302.

Some texels may be stored in the GPU memory 120, and in the texture cache 145, in uncompressed form. These texels may be referred to as “non-compressed” texels, and may be exempt from caching in the post-decompression cache 170, since retrieving such texels repeatedly from the texture cache 145 does not entail repeatedly decompressing them.

Rendering of a pixel may involve determining the color and intensity of light that is reflected from a region of the scene toward the camera. The region of the scene may be a region corresponding to the pixel, and the flight illuminating the region may be light from a light source or from reflections from other surfaces in the scene. Once the GPU 115 has received the texels needed to render one or more pixels (e.g., a set of four adjacent pixels), the rendering may include a mapping process and a filtering process. The mapping process may involve determining the area, within an array (e.g., within a 5x5 array or within a 7x7 array) of adjacent texels, that corresponds to each pixel. Filtering (which may be or include linear filtering, anisotropic filtering, or mipmap filtering) may involve combining the texture characteristics (e.g., color (which may include specular color and diffuse color), transparency, a normal map, or a bump map) of multiple texels, for example to avoid aliasing or blurring. The rendering may also include calculating, based on the texture characteristics, the color and intensity of the light that is reflected toward the camera.

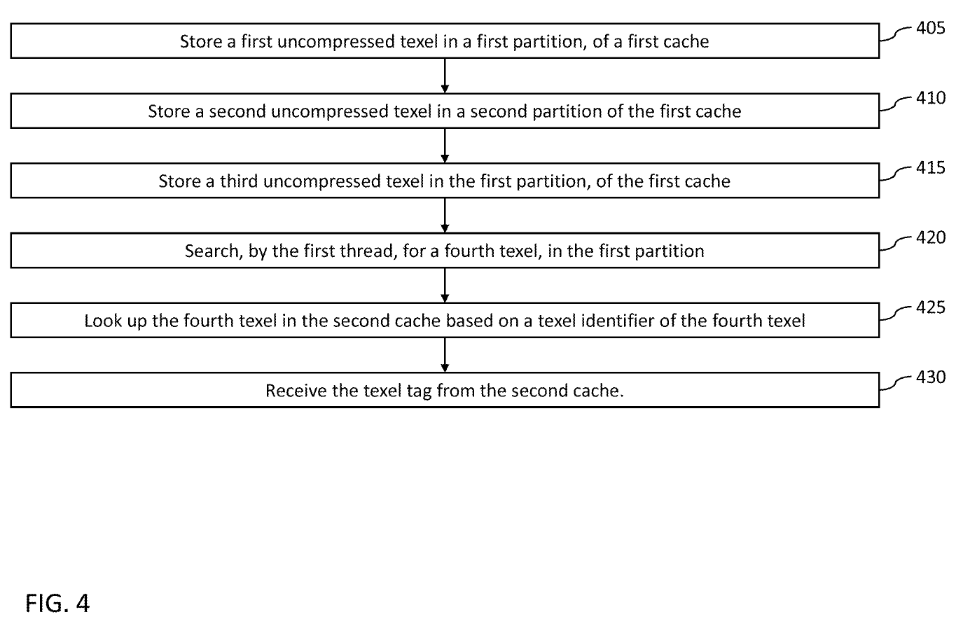

FIG. 4 shows a method of managing texels, in some embodiments. Although FIG. 4 illustrates various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure.

The method may include storing, at 405, by a first thread executing in a processing circuit, a first uncompressed texel in a first partition, of a first cache; and storing, at 410, by a second thread executing in the processing circuit, a second uncompressed texel in a second partition of the first cache, the second partition being different from the first partition. The method may further include storing, at 415 by a third thread executing in the processing circuit, a third uncompressed texel in the first partition, of the first cache, wherein the first thread is part of a first thread group, the third thread is part of the first thread group, and the second thread is part of a second thread group different from the first thread group. In some embodiments, the first thread group renders a first group of pixels, and the second thread group renders a second group of pixels, different from the first group of pixels. In some embodiments, the first group of pixels includes four adjacent pixels. In some embodiments, the first partition is configured to be written only by threads of the first thread group. In some embodiments, the second partition is configured to be written only by threads of the second thread group.

For example, as discussed above in the context of FIG. 2A, the first cache may be a post-decompression cache 170, which may be partitioned, with threads of a first thread group (which may include the first thread, and which may render a first group of pixels (e.g., four adjacent pixels)) accessing only a first partition, and threads of a second thread group (which may include the second thread and which may render a second group of pixels (e.g., four adjacent pixels)) accessing only a second partition.

In some embodiments, the first partition includes: a first way group including one or more ways, and a second way group including one or more ways. In some embodiments, the first way group is configured to be written only by the first thread, and the second way group is configured to be written only by the third thread. In some embodiments, the first way group is configured to be read by the first thread and by the second thread.

For example, as discussed above in the context of FIG. 2A, the first cache (e.g., the post-decompression cache 170) may be asymmetric, with each thread of a thread group writing only to a way group associated with the thread, but reading from (e.g., searching) all of the way groups of the partition associated with the thread group.

The method may further include searching, at 420, for a fourth texel, by the first thread, in the first partition, the fourth texel being identified by a texel identifier; the searching comprising searching a set of texel tags of the first cache for a first texel tag, associated with the fourth texel, the fourth texel being stored in a second cache in compressed form. The method may further include looking up, at 425, the fourth texel in the second cache based on the texel identifier; and receiving, at 430, the texel tag from the second cache. For example, as discussed above in the context of FIGS. 3A – 3C, to search for a texel (e.g., the fourth texel) in the post-decompression cache 170 based on a texel identifier, the thread may first obtain a texel tag corresponding to the texel identifier. It may obtain the texel tag by looking up the texel identifier in the second cache (e.g., in the texture cache 145). Once the lookup is complete, the thread may receive the texel tag from the second cache.

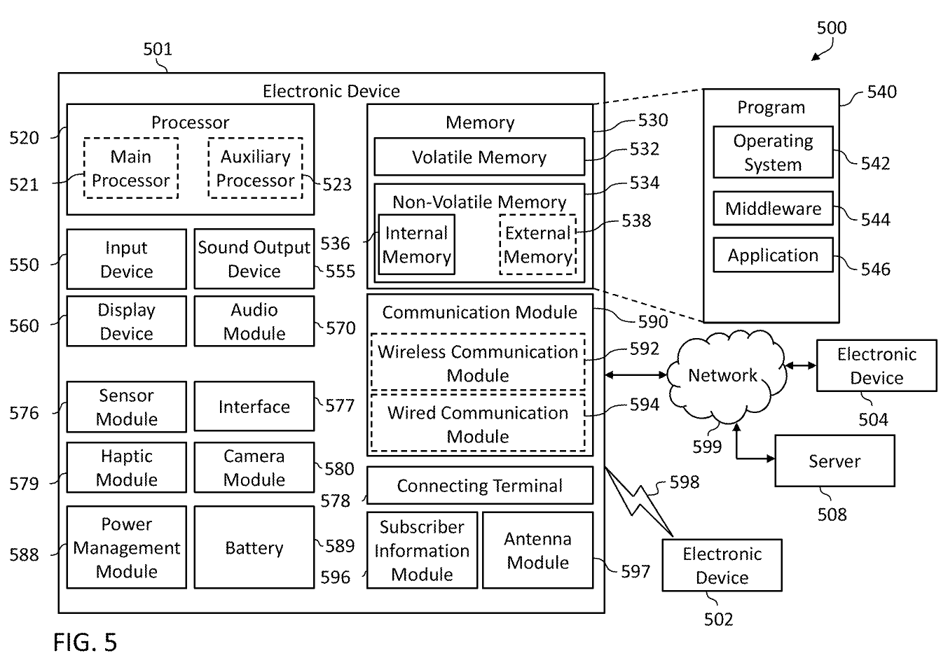

FIG. 5 is a block diagram of an electronic device 501 in a network environment 500, according to an embodiment. Such an electronic device 501 may include a GPU (which may be an example of an auxiliary processor 523) incorporating one or more of the embodiments described herein.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high- definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH^{TM}, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
storing, by a first thread executing in a processing circuit, a first uncompressed texel in a first partition, of a first cache; and
storing, by a second thread executing in the processing circuit, a second uncompressed texel in a second partition of the first cache, the second partition being different from the first partition.

2. The method of claim 1, further comprising storing, by a third thread executing in the processing circuit, a third uncompressed texel in the first partition, of the first cache,
wherein the first thread is part of a first thread group, the third thread is part of the first thread group, and the second thread is part of a second thread group different from the first thread group.

3. The method of claim 2, wherein the first thread group renders a first group of pixels, and the second thread group renders a second group of pixels, different from the first group of pixels.

4. The method of claim 3, wherein the first group of pixels includes four adjacent pixels.

5. The method of claim 2, wherein the first partition is configured to be written only by threads of the first thread group.

6. The method of claim 5, wherein the second partition is configured to be written only by threads of the second thread group.

7. The method of claim 5, wherein the first partition comprises:
a first way group comprising one or more ways, and
a second way group comprising one or more ways.

8. The method of claim 7, wherein the first way group is configured to be written only by the first thread, and the second way group is configured to be written only by the third thread.

9. The method of claim 8, wherein the first way group is configured to be read by the first thread and by the second thread.

10. The method of claim 1, further comprising searching for a fourth texel, by the first thread, in the first partition, the fourth texel being identified by a texel identifier;
the searching comprising searching a set of texel tags of the first cache for a first texel tag, associated with the fourth texel, and
the fourth texel being stored in a second cache in compressed form.

11. The method of claim 10, further comprising:
looking up the fourth texel in the second cache based on the texel identifier; and
receiving the first texel tag from the second cache.

12. A system comprising:
one or more processors; and
a memory storing instructions which, when executed by the one or more processors, cause performance of:
storing, by a first thread executing in a processing circuit, a first uncompressed texel in a first partition, of a first cache; and
storing, by a second thread executing in the processing circuit, a second uncompressed texel in a second partition of the first cache, the second partition being different from the first partition.

13. The system of claim 12, wherein the instructions, when executed by the one or more processors, further cause performance of storing, by a third thread executing in the processing circuit, a third uncompressed texel in the first partition, of the first cache,
wherein the first thread is part of a first thread group, the third thread is part of the first thread group, and the second thread is part of a second thread group different from the first thread group.

14. The system of claim 13, wherein the first thread group renders a first group of pixels, and the second thread group renders a second group of pixels, different from the first group of pixels.

15. The system of claim 14, wherein the first group of pixels includes four adjacent pixels.

16. The system of claim 13, wherein the first partition is configured to be written only by threads of the first thread group.

17. The system of claim 16, wherein the second partition is configured to be written only by threads of the second thread group.

18. The system of claim 16, wherein the first partition comprises:
a first way group comprising one or more ways, and
a second way group comprising one or more ways.

19. The system of claim 18, wherein the first way group is configured to be written only by the first thread, and the second way group is configured to be written only by the third thread.

20. A system comprising:
means for processing; and
a memory storing instructions which, when executed by the means for processing, cause:
storing, by a first thread executing in a processing circuit, a first uncompressed texel in a first partition, of a first cache; and
storing, by a second thread executing in the processing circuit, a second uncompressed texel in a second partition of the first cache, the second partition being different from the first partition.
